(19) United States
(12) Patent Application Publication
(10) Pub. No.: US 2013/0209969 A1
(43) Pub. Date: Aug. 15, 2013

(54) Kit and a Method For Visualizing a Whitening Benefit of a Cosmetic Composition

(71) Applicant: The Procter & Gamble Company, (US)

(72) Inventors: Yaqin WANG, Beijing (CH); Li LI, Beijing (CN); Lin YU, Beijing (CN); PA LA SHA TI, Beijing (CN)

(73) Assignee: THE PROCTER & GAMBLE COMPANY, Cincinnati, OH (US)

(21) Appl. No.: 13/762,536

(22) Filed: Feb. 8, 2013

(30) Foreign Application Priority Data
Feb. 10, 2012 (CN) PCT/CN2012/071032

(51) Int. Cl. G01J 3/52

(52) U.S. Cl. CPC G01J 3/52
USPC 434/98

(57) ABSTRACT

A kit for visualizing to a consumer a whitening benefit provided by a cosmetic composition is provided. The kit comprises a control sample and a product sample, where each of the sample comprises a set of super absorbent polymer beads. The set of beads in the control sample are simultaneously or sequentially contacted with a control sample solution and a melanin generator, and the set of beads in the product sample are simultaneously or sequentially contacted with a product sample solution and a melanin generator. The control sample solution is free of whitening actives, and the product sample solution comprises one or more whitening actives. A method of visualizing to a consumer a whitening benefit provided by a cosmetic composition is also provided.

### FIELD OF THE INVENTION

The present invention relates to a kit for visualizing to a consumer a whitening benefit of a cosmetic composition and a method for visualizing the same.

### BACKGROUND OF THE INVENTION

Melanin plays an important role in protecting human skin from the harmful effects of UV radiation from the sun. However the accumulation of an abnormal amount of melanin in skin results in a dark complexion and/or pigmented patches, which may bring esthetic concerns to consumers.

A number of natural or synthetic ingredients have been identified and clinically proven as skin whitening agents. Some of them function during the stage of signal release from keratinocytes to melanocytes to trigger the melanin synthesis pathway, some others are tyrosinase inhibitors and function during the stage of melanogenesis within melanosomes, some others function during the stage of melanosome and/or melanin transfer from melanocytes to keratinocytes, and still some others function during the stage of melanin degradation and desquamation in the keratinocytes.

Cosmetic compositions comprising one or more of such whitening actives and providing chronic skin whitening benefit are desirable to consumers, particularly Asian consumers and consumers living in tropical regions, who may prefer light skin complexions.

However, before a chronic skin whitening effect can be perceived, the cosmetic compositions comprising such whitening actives must be applied for a relatively long period of time, such as a few months. This lengthy period of time poses a challenge in convincing the consumers about the whitening benefit of the cosmetic composition, and thereby poses a challenge in encouraging a purchase decision.

Hence, there exists a need for a convenient and stable demonstration tool for visualizing the whitening benefit of a cosmetic composition comprising one or more whitening actives to the consumers.

### SUMMARY OF THE INVENTION

In one aspect of the present application, it relates to a kit for visualizing to a consumer a whitening benefit provided by a cosmetic composition, where the kit comprises:
a) a control sample comprising a first set of super absorbent polymer beads which are simultaneously or sequentially contacted with
   i. a control sample solution comprising a base formulation, wherein said base formulation is free of whitening actives, and
   ii. a first amount of a melanin generator;
b) a product sample comprising a second set of super absorbent polymer beads which are simultaneously or sequentially contacted with
   i. a product sample solution comprising said cosmetic composition which comprises said base formulation and one or more whitening actives, and
   ii. a second amount of a melanin generator;
      wherein melanin appears in each sample as indicated by a color change of each set of beads, and wherein the appearance of melanin in the product sample is diminished and such diminishment is visually perceivable by the consumer as a less intense color change than the color change exhibited by said control sample in which such diminishment is absent.

In another aspect of the present application, it relates to a method for visualizing to a consumer a whitening benefit of a cosmetic composition, where the method comprises the steps of:
a) providing a first set of super absorbent polymer beads,
b) contacting said first set of super absorbent polymer beads with a control sample solution comprising a base formulation, wherein said base formulation is free of whitening actives,
c) providing a second set of super absorbent polymer beads,
d) contacting said second set of super absorbent polymer beads with a product sample solution comprising said cosmetic composition, wherein said cosmetic composition comprises said base formulation and one or more whitening actives,
e) contacting each of said first and second set of super absorbent polymer beads with a melanin generator, wherein each set of beads exhibit a color change after said contact with said melanin generator,
f) comparing the color of said first and second set of super absorbent polymer beads,
   wherein steps b) and d) occur before step e), after step e), or simultaneously with step e), and wherein step f) is the last step.

### BRIEF DESCRIPTION OF THE DRAWINGS

FIG. 1A depicts an individual bead from a set of beads from the product sample of Example 1 after 3 hours of contact with the melanin generator.

FIG. 1B depicts an individual bead from a set of beads from the control sample of Example 1 after 3 hours of contact with the melanin generator.

FIG. 1C depicts the liquid product sample of Comparative Example, after 3 hours of contact with the melanin generator.

FIG. 1D depicts the liquid control sample of Comparative Example 1, after 3 hours of contact with the melanin generator.

FIG. 2A depicts an individual bead from a set of beads from the product sample of Example 1 after 3.5 hours of contact with the melanin generator.

FIG. 2B depicts an individual bead from a set of beads from the control sample of Example 1 after 3.5 hours of contact with the melanin generator.

FIG. 2C depicts an individual bead from a set of beads from the product sample of Example 2 after 3.5 hours of contact with the melanin generator.

FIG. 2D depicts an individual bead from a set of beads from the control sample of Example 2 after 3.5 hours of contact with the melanin generator.

FIG. 3 depicts an individual bead (10) from a set of beads from the product sample and an individual bead (15) from a set of beads from the product sample of Example 2 after 3.5 hours of contact with the melanin generator, and such beads (10, 15) have been allowed to remain untouched for two weeks.

The photographs of the beads have been enlarged relative to the photographs of the liquid samples to clearly illustrate the color differences between the product samples and control samples.

### DETAILED DESCRIPTION OF THE INVENTION

While the specification concludes with the claims particularly pointing and distinctly claiming the invention, it is believed that the present invention will be better understood from the following description.

All percentages, parts and ratios used herein are weight based unless otherwise specified.

The present kit provides a convenient and stable tool for demonstrating the whitening benefit of a cosmetic composition which comprises one or more whitening actives.

The present kit is advantageous over a liquid demonstration system comprising a control liquid sample and a product liquid sample due to the use of super absorbent polymer beads in the kit. The color difference between the beads of the control sample and the beads of the product sample in the present kit is more vividly distinct than the color difference between a control liquid sample and a product liquid sample in the liquid demonstration system. Without being bound by theory, it is believed that the beads serve as an appropriate medium for absorbing and retaining the melanin generator for both the control sample and the product sample in their crosslinked network structure, while such benefits do not exist in a liquid demonstration system.

Furthermore, the color change rendered by the presence of melanin can be more conveniently controlled and maintained in the present kit than in the liquid demonstration system. This convenience results because the beads can be easily removed from contact with the melanin generator after an appropriate length of time, while this convenience does not exist in the liquid demonstration system since the contact persists there.

### Super Absorbent Polymer Beads

The control sample of the present kit comprises a first set of super absorbent polymer beads, and the product sample of the present kit comprises a second set of super absorbent polymer beads. The first and second sets of super absorbent polymer beads are preferably made from the same super absorbent polymer material.

The super absorbent polymer (SAP) material can absorb and retain large amounts of liquid relative to its own mass. The SAP beads made from the SAP material have a crosslinked “network” structure, which allows the material to draw liquid across a diffusion gradient such that the liquid is held in the network.

A number of SAP materials are readily available from commercial sources to make the SAP beads. The most common type of SAP beads are made from polyacrylic acid sodium salt (i.e. sodium polyacrylate). Other materials are also used to make a SAP beads, such as polyacrylamide copolymer, ethylene maleic anhydride copolymer, crosslinked carboxymethylcellulose, polyvinyl alcohol copolymers, crosslinked polyethylene oxide, and starch grafted copolymer of polyacrylonitrile and the like.

The absorbency and swelling capacity of the SAP beads are controlled by the type and degree of crosslinkers within the SAP material. Low density crosslinked SAP beads generally have a relatively higher absorbent capacity and swell to a relatively higher degree, and their gel strength is soft and they are sticky. High density crosslinked SAP beads exhibit a relatively lower absorbent capacity and swells to a relatively lower degree, but their gel strength is firmer and they can maintain particle shape even under modest pressure. The fluid absorption rate of a SAP bead can be expressed as the weight ratio of such SAP bead after and before being wetted with a fluid for a whole of 24 hours. Suitable SAP beads for the present kit has a fluid absorption rate of from about 50 and about 200 to about 500 and about 2000.

The SAP beads can be divided into two categories, depending on the liquid they absorb. One category of the SAP beads are water absorbing SAP beads, the other category are oil-absorbing SAP beads. Both categories of beads are useful for the present invention.

The water absorbing SAP beads hold water in the network by the hydrogen bonds between the hydrophilic groups, such as between the carboxylates of the polymer and the water molecules. Then, the SAP beads expand as water moves into the network. An aqueous solution to be absorbed by the SAP beads comprises water and solutes such as organic salts, skin whitening actives et al. The solutes in the aqueous solution can also be absorbed into the beads with or after water, depending on the solute's molecular size and the expansion of the empty spaces in the network of the SAP beads.

The water absorbing SAP beads' absorption rate is affected by the ionic strength of the aqueous solution it absorbs as the presence of cations in the solution impede the polymers' ability to bond with the water molecule.

Suitable SAP beads are useful in various shapes, including spheres, ellipses, pyramids, cubes, cylinders, cones, stars, and irregular shapes. Suitable SAP beads are also useful in various sizes. Preferably, the SAP beads are small spheres, and preferably have a diameter of from about 1 cm, about 1.5 to about 2, and about 2.5 cm after 24 hours of absorption.

Exemplary water absorbing SAP beads useful for the present kit include, but not limited to sodium polyacrylate resin beads supplied by Shenzhen Greenbar Sci-Tech Co., Ltd. under the name of Crystal Soil series, and polyacrylamide copolymer with polyacrylic acid polyacrylamide resin supplied by Chemole Aqua Sorbent Technology (Beijing) Co., Ltd. under the name of Crystal Soil series.

The oil-absorbing SAP beads retain oil as a result of Van der Waal forces between the hydrophobic groups of the SAP and the oil. One exemplary oil-absorbing SAP bead is made from lauryl acrylate crosslinking polymer.

In one embodiment of the present kit, each of the first bead and said second bead is held in a transparent container.

### Control Sample Solution and Product Sample Solution

The present kit comprises a control sample comprising a control sample solution and a product sample comprising a product sample solution.

The control sample solution comprises a base formulation which is free of whitening actives. The product sample solution comprises a cosmetic composition which comprises the base formulation and one or more whitening actives.

The control sample solution and the product sample solution each has a pH of from about 3, about 5, and about 6 to about 7, about 8, and about 10.

The control sample solution and the product sample solution each has an ionic strength of less than about 0.5 mol/L, about 0.25 mol/L or about 0.12 mol/L.

Each of the control sample solution and product sample solution has a viscosity of less than 40,000 cps.

The volume of the control sample solution and the product sample solution used in the present kit needs to be in proportion to the amount of super absorbent beads used, so that each of the beads can sufficiently contact the solution. For instance, when there is a set of 10 to 15 super absorbent beads, each of the solutions in the present kit has a volume of about 50 ml.

### Base Formulation

The base formulation can be provided in the form of a cream, an emulsion, a lotion, a toner, water, et al.

In one instance when the viscosity of a base formulation is less than 40,000 cps, it can be used as is for the control sample solution. In another instance when the viscosity of a base formulation is equal to or greater than 40,000 cps, the control sample solution is prepared by diluting the base formulation with water, other suitable solvents, or other suitable low viscosity base formulations to bring the viscosity down to less than 40,000 cps.

### Whitening Actives

The present kit is used to visualize the whitening efficacy of a cosmetic composition comprising whitening actives.

Suitable whitening actives for which the whitening efficacy can be visualized by the present kit include, but are not limited to, niacinamide, undecylenoyl phenylalanine (Sepiwhite), inositol, tocopherol acetate, panthenol, ascorbyl glucoside, hesperidin, vitamin C, vitamin C derivative, hexyldecanol, arbutin, ellagic acid, hydroquinone, retinol, N-acetyl glucosamine and the like.

Preferably, the whitening benefit is a melanogenesis inhibition benefit. Preferably, the whitening actives are tyrosinase inhibitors. Suitable whitening actives are selected from the group consisting of vitamin C, vitamin C derivative, hexyldecanol, arbutin, ellagic acid, hydroquinone, retinol, N-acetyl glucosamine, and mixtures thereof.

Depending on varied whitening potency of the whitening actives, the amount of such whitening actives required to be included in the product sample solution for the kit to visualize whitening benefit to a consumer may vary, and this is due to the difference in terms of the color diminishment by the whitening actives in the product sample as compared with the control sample. For example, niacinamide can be used in the product sample solution at a lowest amount of about 0.1%, and hexyldecanol can be used in the product sample solution at a lowest amount of about 0.1%.

### Melanin Generator

Each of the control sample and the product sample in the present kit comprises a set of SAP beads which are contacted with a melanin generator. The melanin generator is a combination of ingredients, and upon chemical reaction between the ingredients melanin is generated. As used herein, the term “melanin” is to be construed in a broader sense to include eumelanin, phenomelanin or their colored precursors. Eumelanin is a black pigment, and phenomelanin is a red or yellow pigment, which are species of melanin found dominant in different ethnicities of people.

Without being limited by theory, the melanin generation pathway is initiated with a first step of tyrosine oxidation to dopaquinone catalyzed by tyrosinase. This first step is the rate-limiting step and the remainder of the reaction sequence can proceed spontaneously at a physiological pH value. The dopaquinone is subsequently converted to dopa (dihydroxyphenylalanine) and dopachrome through auto-oxidation. Dopa is also the substrate of tyrosinase and oxidized to dopaquinone again by the enzyme. Finally, eumelanin is formed through a series of oxidation reactions from dihydroxyindole (DHI) and dihydroxyindole-2-carboxylic acid (DHICA), which are the reaction products from dopachrome.

In the absence of cysteine and/or glutathione, the melanogenesis reaction initiated by the tyrosine/tyrosinase or dopa/tyrosinase generates eumelanin. In the presence of cysteine and/or glutathione, the melanogenesis reaction initiated by the tyrosine/tyrosinase or dopa/tyrosinase is directed to a different pathway and generates phenomelanin.

An exemplary melanin generator includes tyrosine/tyrosinase preparation. The melanin generator can be prepared by combining the ingredients into a single solution. It can also be made by preparing a solution of each ingredient, and combining these solutions immediately before their use to form the melanin generator. Preferably, the molar amount of tyrosine in the tyrosine/tyrosinase preparation is in excess of what is required by the tyrosinase to complete the reaction.

Tyrosine has a solubility in water of 0.453 mg/ml at 25° C. A saturated tyrosine solution of can be suitably prepared and used in the present kit. A higher concentration of tyrosine solution can also be prepared by decreasing the pH of the aqueous solution with an acidic pH adjuster, e.g. HCl. The tyrosinase can be prepared at a concentration of at least about 10 μg/ml, preferably at least about 100 μg/ml.

Another suitable melanin generator is a dopa/tyrosinase solution. The molar amount of dopa in the melanin generator is also preferably in excess of what is required by the tyrosinase to complete the reaction.

The melanin generator can further comprise cysteine and/or glutathione in the tyrosine/tyrosinase preparation, or dopa/tyrosinase preparation, if visualization of whitening benefit by inhibiting the phenomelanin is particularly desirable.

### Method of Visualizing

In a second aspect of the present application, it relates to a method for visualizing to a consumer a whitening benefit of a cosmetic composition, said method comprising the steps of:
a) providing a first set of super absorbent polymer beads,
b) contacting said first set of super absorbent polymer beads with a control sample solution comprising a base formulation, wherein said base formulation is free of whitening actives,
c) providing a second set of super absorbent polymer beads,
d) contacting said second set of super absorbent polymer beads with a product sample solution comprising said cosmetic composition, wherein said cosmetic composition comprises said base formulation and one or more whitening actives,
e) contacting each of said first and second set of super absorbent polymer beads with a melanin generator, wherein each set of beads exhibit a color change after said contact with said melanin generator,
f) comparing the color of said first and second set of super absorbent polymer beads.

Each of the contacting steps b) and d) can optionally occur sequentially or simultaneously with step e).

In order for each of the SAP beads to sufficiently expand and thereby absorb a sufficient amount of the control sample solution or product sample solution, the SAP beads preferably contact the appropriate solution for at least about 2 hours.

In order for the present method to show a perceivable color difference between the control sample and the product sample, the contact period of the SAP beads with the melanin generator should be controlled to avoid an excessive amount of melanin being generated and absorbed into the SAP beads. Generally, when the amount of the whitening actives in the product sample solution is relatively high, then the contacting period can be longer. In contrast, when the amount of the whitening actives in the product sample solution is relatively low, then the contacting period can be shorter. In one embodiment, where the product sample solution comprises a relatively high level of 5% of niacinamide, the SAP beads contact the melanin generator for less than 8 hours.

### Method of Measurement

### Viscosity

The viscosity can be measured by one skilled in the art using a commercially available viscometer. For example, a RV viscometer with TC spindle and model D Helipath Stand supplied by Brookfield Engineering Laboratories, Inc is used, at a rotation speed of 5 rpm.

### Ionic Strength

The ionic strength of a solution is a measure of the concentration of ions in that solution. It can be calculated according to the following equation.

$$I = \frac{1}{2} {\sum }_{i - 1}^{n} {c}_{i} {z}_{i}^{2}$$

### Wherein

I is the ionic strength,
Cᵢ is the molar concentration of an ion, the unit of Cᵢ is mol/L,
Zᵢ is the of ion number of the ion, e.g for Mg²⁺, it is +2.

### EXAMPLES

The following examples further describe and demonstrate embodiments within the scope of the present invention. The examples are given solely for the purpose of illustration and are not to be construed as limitations of the present invention, as many variations thereof are possible without departing from the spirit and scope of the invention.

Example 1 relates to a kit comprising
a control sample comprising a first set of sodium polyacrylate resin beads which is first contacted with a control sample solution comprising a base formulation, and then contacted with a tyrosine/tyrosinase preparation;
a product sample comprising a second set of sodium polyacrylate resin beads which is first contacted with a product sample solution comprising a base formulation and hexyldecanol, and then contacted with a tyrosine/tyrosinase preparation;

Example 2 relates to a kit which is essentially the same as the kit of claim 1, except the product sample solution comprises a higher level of hexyldecanol.

Comparative Example 1 includes a control liquid sample and a product liquid sample. The control liquid sample comprises the control sample solution of Examples 2 and the tyrosine/tyrosinase preparation. The product liquid sample comprises the product sample solution of Example 2 and the tyrosine/tyrosinase preparation. The Comparative Example 1 samples can be prepared through conventional mixing techniques. The amount of control sample solution and the product sample solution mixed with 50 ml of tyrosine/tyrosinase preparation equals about 5.8 g, the average weight of a wetted sodium polyacrylate resin bead used in Example 2.

### Materials

1) Sodium polyacrylate resin beads supplied by Shenzhen Greenbar Sci-Tech Co. Ltd under the name of Crystal Flower Soil.
2) L-tyrosine supplied by Sigma-Aldrich (Shanghai) Trading Co., Ltd
3) Tyrosinase, product code T3824-50KU supplied by Sigma-Aldrich (Shanghai) Trading Co., Ltd,
4) Base formulation

A base formulation comprising the following ingredients is provided.

TABLE 1

| | Ingredients (INCI) | Concentration (wt %) |
|---|---|---|
| 1 | Isopropyl isostearate | 1.33 |
| 2 | Isohexadecane | 3.0 |
| 3 | Sucrose Polycottonseedate | 0.67 |
| 4 | Vitamin E acetate | 0.5 |
| 5 | Cetyl alcohol | 0.32 |
| 6 | Stearyl alcohol | 0.48 |
| 7 | Behenyl alcohol | 0.4 |
| 8 | Cetearyl Glucoside and cetearyl alcohol | 0.20 |
| 9 | Polyoxyethylene 100 stearate | 0.10 |
| 10 | Ethylparaben | 0.2 |
| 11 | Propyl paraben | 0.10 |
| 12 | Polymethylsilesquloxane | 0.25 |
| 13 | Water | 84.75 |
| 14 | Glycerine | 3.0 |
| 15 | Disodium EDTA | 0.3 |
| 16 | Polyacrylamide & C13-14 isoparafin | 2.0 |
| 17 | Benzyl alcohol | 0.40 |
| 18 | Dimethicone (and) Dimethiconol | 2.0 |
| | Total | 100 |

This base formulation is prepared as follows. First, a hydrophobic component premix is prepared by combining ingredients 1-12 and mixing at a temperature of 75±2° C. Then a hydrophilic premix is prepared by combining ingredients 13-15 and mixing at the same temperature. Then, the hydrophobic and hydrophilic premixes are blended and mixed well. Afterwards, the blend is cooled down to about 50° C. and the remaining ingredients 16-18 are added and mixed in.

The cosmetic compositions of Examples 1 and 2 are prepared by first blending hexyldecanol into the above base formulation to provide a cosmetic composition comprising respectively 0.1% and 5% of hexyldecanol.

The viscosity of each base formulation and cosmetic composition is about 80,000 cps. The control sample solution and the product sample solution are prepared by diluting the base formulation and the cosmetic composition with water at a dilution rate of 1:4, where the viscosity drops to about 1000 cps.

The ionic strength of the control sample solution and the product sample solution are respectively about 0.018.
5) Melanin generator (tyrosine/tyrosinase preparation)

The tyrosine/tyrosinase preparation is made by first preparing a separate tyrosine solution and a separate tyrosinase solution, and then combining the two solutions immediately before their use as a melanin generator.
5.1) Tyrosine solution
   A saturated tyrosine solution is prepared by adding 2000 mg L-tyrosine into deionized water and mixing to provide a 100 ml solution. As the water solubility of tyrosine is 0.453 mg/ml, a saturated tyrosine solution results.
5.2) Tyrosinase solution, 100 ug/ml
   The tyrosinase solution is prepared by adding 0.01g tyrosinase into deionized water and mixing to provide a 100 ml solution.

Procedures

The product sample of each of Example 1 and 2 is prepared according to the following steps:
1) put a first set of 10 beads in 50 ml of product sample solution,
2) keep the beads immersed for 24 hours at room temperature,
3) remove the beads,
4) rinse the beads with deionized water,
5) put the beads in a clean beaker,
6) pour 50 ml tyrosine solution into the beaker,
7) add 2 ml tyrosinase solution into the beaker, and mix well,
8) keep the beads immersed in the tyrosine/tyrosinase preparation,
9) remove a few beads after contacting the tyrosine/tyrosinase solution for 3 hours and 3.5 hours respectively,
10) rinse the beads with deionized water,

The control sample is prepared essentially the same, except that the beads are incubated in 50 ml of control sample solution.

One bead is removed from each set of beads in the product sample and the control sample of Examples 1-2 after contacting the tyrosine/tyrosinase preparation for 3 hours. Another bead is removed from each set after contacting the tyrosine/tyrosinase preparation for 3.5 hours. Photos are taken for each of these beads, and then the extents of color change in each bead are compared.

6) Control liquid sample and product liquid sample

The Comparative Example 1 comprises a control liquid sample and a product liquid sample. Each sample is prepared through conventional mixing techniques. The control liquid sample is prepared by mixing a predetermined amount of control sample solution and the product sample solution used in the kit of present Example 1 with 50 ml of tyrosine/tyrosinase preparation. The control product sample is prepared by mixing a predetermined amount of product sample solution used in the kit of present Example 1 with 50 ml of tyrosine/tyrosinase preparation.

The above mentioned predetermined amount equals about 5.8 g, the average weight of a wetted sodium polyacrylate resin bead used in Example 1.

The color of the control liquid sample and product liquid sample of Comparative Example 1 are also compared at 3 hours after each of the control sample solution and the product sample solutions are added to the tyrosine/tyrosinase preparation, and photos are taken.

### Visualization Results

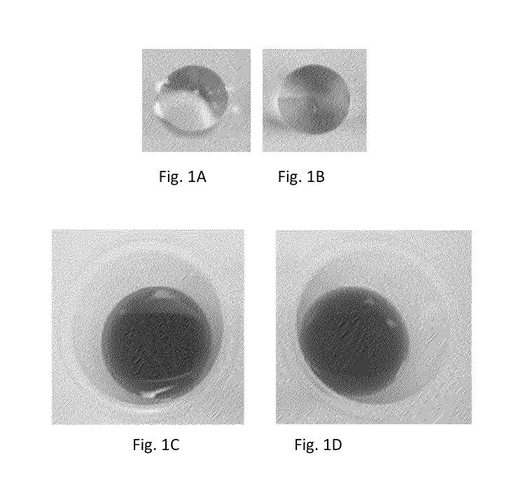

Each of FIGS. 1A-1B depict an individual bead from each of the set of beads from the product sample and the control sample of Example 1, and each of the beads have been removed from their respective solution 3 hours after contact with the melanin generator. Clearly, the product sample bead shown in FIG. 1A has undergone a less intense color change than the control sample of FIG. 1B, indicating and visualizing to a consumer the whitening benefit of the cosmetic composition utilized in the product sample. A group of 14 panelist are asked to rate the color change intensity difference between the beads shown in FIGS. 1A and 1B. Of the 14 panelists, 8 rate the difference as “perceivable”, the other 6 rate the difference as “strongly perceivable”.

Each of FIGS. 1C-1D depict the liquid product sample and the liquid control sample of Comparative Example 1 after 3 hours of contact with the melanin generator. Clearly, the liquid product sample and the liquid control sample have essentially the same color change, thus not indicating and visualizing to a consumer the whitening benefit of the cosmetic composition utilized in the product sample. The same group of 14 panelists are asked to rate the color change intensity difference between each of the liquid sample shown in FIGS. 1C and 1D. Of the 14 panelists, 11 panelists rate the difference as “not perceivable”, the other 3 panelist rate it as “perceivable”.

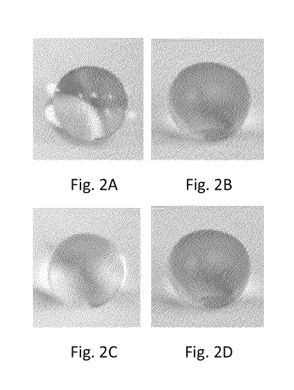

Each of FIGS. 2A-2B depict an individual bead from each of the set of beads from the product sample and the control sample of Example 1, and each of the beads have been removed 3.5 hours after contact with the melanin generator. Similarly, the product sample bead shown in FIG. 2A has undergone a less intense color change than the control sample of FIG. 2B indicating and visualizing to a consumer the whitening benefit of the cosmetic composition utilized in the product sample. The same group of 14 panelist are asked to rate the color change intensity difference between the beads shown in FIGS. 2A and 2B. Of the 14 panelists, 7 rate the difference as “perceivable”, the other 7 rate the difference as “strongly perceivable”.

Each of FIGS. 2C-2D depict the individual beads which are essentially the same as those shown in FIGS. 1A-1B, except they are from Example 2. Clearly, the product sample bead shown in FIG. 2C has undergone a less intense color change than the control sample of FIG. 2D indicating and visualizing to a consumer the whitening benefit of the cosmetic composition utilized in the product sample. The same group of 14 panelist are asked to rate the color change intensity difference between the beads shown in FIGS. 2A and 2B. All 14 panelists rate the difference as “strongly perceivable”.

### Stability of the Kit

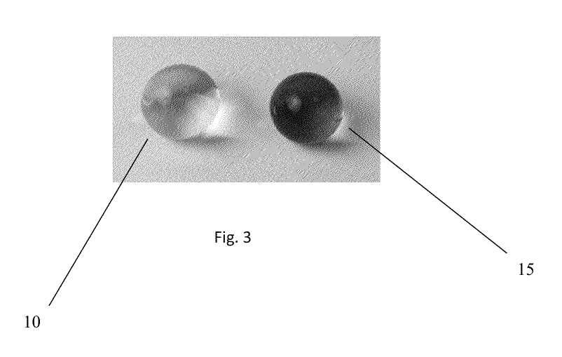

The present kit is a stable and convenient tool for visualizing to consumers the whitening benefit of a cosmetic composition. The extent of the color difference between the control sample and the product sample in the present kit remains substantially unchanged for a long time, for example up to 3 months, though the color of each of the control sample and product sample may turn a bit darker due to some of the melanin precursors transforming into melanin. FIG. 3 illustrates the color difference between a bead from the product sample 10 and a bead from the control sample 15. Such beads 10, 15 have been removed from their respective solutions 3.5 hours after contact with the melanin generator and have been allowed to remain untouched for two weeks. Clearly, the product sample bead 10 has undergone a less intense color change than the control sample 15 indicating and visualizing to a consumer the whitening benefit of the cosmetic composition utilized in the product sample.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A kit for visualizing to a consumer a whitening benefit provided by a cosmetic composition, said kit comprising:
a) a control sample comprising a first set of super absorbent polymer beads which are simultaneously or sequentially contacted with
i. a control sample solution comprising a base formulation, wherein said base formulation is free of whitening actives, and
ii. a first amount of a melanin generator;
b) a product sample comprising a second set of super absorbent polymer beads which are simultaneously or sequentially contacted with
i. a product sample solution comprising said cosmetic composition which comprises said base formulation and one or more whitening actives, and
ii. a second amount of a melanin generator;
wherein melanin appears in each sample as indicated by a color change of each set of beads, and wherein the appearance of melanin in the product sample is diminished and such diminishment is visually perceivable by the consumer as a less intense color change than the color change exhibited by said control sample in which such diminishment is absent.

2. The kit of claim 1, wherein each set of beads have a fluid absorption rate of from about 200 to about 2000.

3. The kit of claim 1, wherein each set of beads are sodium polyacrylate resins beads.

4. The kit of claim 1, wherein said melanin generator is selected from the group consisting of a tyrosine/tyrosinase preparation, a dihydroxyphenylalanine/tyrosinase preparation, and mixtures thereof.

5. The kit of claim 1, wherein each of said control sample solution and product sample solution has a viscosity of less than about 40,000 cps.

6. The kit of claim 1 or 5, wherein each of said control sample solution and the product sample solution has an ion strength of less than about 0.5 mol/L.

7. The kit of claim 6, wherein each of said control sample solution and the product sample solution has a pH of from about 5 to about 8.

8. The kit of claim 1, wherein said whitening benefit is melanogenesis inhibition.

9. The kit of claim 1, wherein said one or more whitening actives are tyrosinase inhibitors selected from the group consisting of vitamin C, vitamin C derivatives, hexyldecanol, arbutin, ellagic acid, hydroquinone, retinol, N-acetyl glucosamine, and mixtures thereof.

10. The kit of claim 1, wherein each of said control sample and product sample is placed in a transparent container.

11. A method for visualizing to a consumer a whitening benefit of a cosmetic composition, said method comprising the steps of:
a) providing a first set of super absorbent polymer beads,
b) contacting said first set of super absorbent polymer beads with a control sample solution comprising a base formulation, wherein said base formulation is free of whitening actives,
c) providing a second set of super absorbent polymer beads,
d) contacting said second set of super absorbent polymer beads with a product sample solution comprising said cosmetic composition, wherein said cosmetic composition comprises said base formulation and one or more whitening actives,
e) contacting each of said first and second set of super absorbent polymer beads with a melanin generator, wherein each set of beads exhibit a color change after said contact with said melanin generator,
f) comparing the color of said first and second set of super absorbent polymer beads,
wherein each of step b) and d) occurs before step e), after step e), or simultaneously with step e), and wherein step f) is the last step.

12. The method of claim 11, wherein the contacting step in each of step b) and d) lasts more than 2 hours.

13. The method of claim 11 or 12, wherein the contacting step in step e) lasts less than 8 hours.

14. The method of claim 11, wherein each set of beads have a fluid absorption rate of from about 200 to about 2000.

15. The method of claim 11, wherein each set of beads are sodium polyacrylate resins beads.

16. The method of claim 11, wherein said melanin generator is selected from the group consisting of a tyrosine/tyrosinase preparation, a dihydroxyphenylalanine/tyrosinase preparation, and mixtures thereof.

17. The method of claim 11, wherein each of said control sample solution and the product sample solution has a viscosity of less than about 40,000 cps.

18. The method of claim 11 or 17, wherein each of said control sample solution and the product sample solution has an ion strength of less than about 0.5 mol/L.

19. The method of claim 18, wherein each of said control sample solution and the product sample solution has a pH of from about 5 to about 8.

20. The method of claim 11, wherein said whitening benefit is melanogenesis inhibition.

21. The method of claim 11, wherein said one or more whitening actives are tyrosinase inhibitors selected from the group consisting of vitamin C, vitamin C derivatives, hexyldecanol, arbutin, ellagic acid, hydroquinone, retinol, N-acetyl glucosamine, and mixtures thereof.

22. The method of claim 11, wherein each of said control sample and product sample is placed in a transparent container.
